(19) United States
(12) Patent Application Publication
(10) Pub. No.: US 2022/0264255 A1
(43) Pub. Date: Aug. 18, 2022

(54) NETWORK UNILATERAL COMMUNICATION LOCATION ELECTRONIC UNDERPINNING SYSTEM

(71) Applicant: Craig Walden Grass, Seattle, WA (US)

(72) Inventor: Craig Walden Grass, Seattle, WA (US)

(21) Appl. No.: 17/665,667

(22) Filed: Feb. 7, 2022

Related U.S. Application Data
(60) Provisional application No. 63/149,363, filed on Feb. 15, 2021.

(51) Int. Cl. H04W 4/029; G06F 9/451

(52) U.S. Cl. CPC H04W 4/029; G06F 9/451

(57) ABSTRACT

This Invention is a process for developing an infrastructure of interactive virtual data registry nodes that act as virtual reference points in 3D physical environment which only this invention can see and interact with to create a platform upon which location and navigation services, or any service that requires precise measurement, can be hosted and the process includes the development and placement of a universal grid of interactive virtual data registry nodes that interact with a virtual sensor or peripheral which prompt the system per this inventions programmed design to display the information stored in the registry that is tied to that virtual data registry node's precise location and when the sensor/peripheral comes into contact with the virtual data registry node the corresponding information, by the design of this process, is automatically display in three forms: readable data, 2D format and 3D format on the display of the machines computer or electronic device that is running the virtual/physical software program.
Further, this new process develops a location communication grid via an interactive virtual software program that forms its own network of virtual data registry nodes that reference location and other pertinent data to provide environmental awareness pertinent to obstacle avoidance, measurement, location, navigation and other pertinent information such as regulations and restrictions to both electronic devices and computers imbedded into the operating system of machines without the use of outward infrastructure such as GPS or satellite triangulation to provides real time data to optimize safety for individuals, as well as driven & autonomous ground, water and air machines. The Software program uses virtual data registry nodes placed from a depth of 12,000 m below sea level up to the outer edges of the upper atmosphere that reference precise location data via a software connected sensor/peripheral that is programmed to interact with the virtual data registry node.

Additionally, each device or machine has its own unique digital representation or visualization within the program based on the exact dimensions of the device or machines virtual location which is synced with its actual 3D physical location.

Finally, an advanced use of this system conjoins an advanced version of this process best described as programmed intelligence and a virtual/physical syncing process that happens at a million times per second to enable the machine or device to know its exact location without any outward infrastructure by syncing precise virtual data with the natural and manmade physical data via sensors.

### TECHNICAL FIELD

This invention teaches a universal interactive virtual underpinning infrastructure that improves location, navigation & measurement services by utilizing a software programmed network of fixed interactive virtual data registry nodes of which some are used to provide reality placed virtual reference points that reference precise location data & other pertinent information on a registry & others that are used to sync with manmade and natural structural formations to create boundaries for baseline obstacle avoidance to improve machine safety as it pertains to ground, water and air navigation for electronic devices, vehicles, vessels & aircraft enhancing flight safety, road safety, water safety, military targeting, construction and other measurement related accuracy.

### BACKGROUND OF THE INVENTION

A software program is a series of commands or instructions that tell a computer what to do that allow for certain computer operations that accomplish tasks internally & externally via circuits & connected peripherals. Examples of connected peripherals include keyboards, microphones, cameras, sensors and a screen to view the information captured to accomplish a multitude of tasks.

Virtual reality is a computer-generated simulation of a three-dimensional image or environment that can be interacted with in a seemingly real or physical way by a person using special electronic equipment, such as a helmet with a screen inside or gloves fitted with sensors.

Computers and devices are a series of electronic circuits that use power to process and store information via software programs that can utilize various connected devices & input/output peripherals.

Current software programs used for ground navigation include Google Maps, Google Earth, Apple Maps, Bing Maps, MapQuest to mention the most popular, and these programs rely on a triangulation of multiple satellite connections.

The Software Advantage is that it provides a set of instructions that tell a computer what to do and comprises the entire set of programs, procedures, and routines associated with the operation of any computer system.

The virtual software advantage is that it provides the ability to place virtual information in a physical 3D environment and with the use of peripherals users can interact with the virtual aspects of the environment.

Location & Navigational aids include Automatic direction finder (ADF), inertial navigation compasses, radar navigation, VHF omnidirectional range (VOR), Global navigation satellite systems (GNSS) & GPS (Global Positioning System), which is a type of GNSS; Pilots use at least one if not multiple aids to assist in knowing their approximate location.

One drawback of the existing Location Software solutions are their lack of precision and thus far reliability. As personal and private piloted and autonomous VTOL aircraft enter our skies and as more autonomous vehicles appear on the roads, the more precise our Location Service will need to be. GPS, as seen used with existing online mapping services, provides an approximate location and reliability can vary depending on the location of the user & satellite or cellular connection where some inner-city areas & rural areas have difficulty providing accurate information.

One drawback of existing self-driving technology is that it is limited to a GPS signal and physical line of sight with no ability to see what is happening with other pertinent machines that may be relevant to its course or path but out of sight.

This invention presents a highly precise foundation upon which location, navigation and measurement services can be built and rendered that is accurate to less than one inch of the device, vehicle, vessel, submersible, train or aircraft's actual location anywhere in the world above or below ground or water and can extended to the outer atmosphere and does not rely on GPS, physical line of sight or satellites to know its location.

### SUMMARY OF THE INVENTION

Accordingly, there is a need in the field for this invention.

This present invention utilizes the universal network of plotted interactive virtual data registry nodes that only this invention can see, read and interact with. This invention uses the virtual data registry node as a reference point and each node refers to a specific entry in the registry which contains the location & pertinent information specific to that exact location. That information is used in conjunction with physical global environmental data synced with virtual data to provide an accurate location read out as well as 2D and 3D visualization of said machine's exact location with respect to the machines surrounding environmental relevant data such as structures, towers, wires, hills, mountains, landscape and outcroppings. Example: An Aircraft needs to know the classification of its immediate Airspace as well as its exact location within that three-dimensional Airspace. There can be multiple classifications of the immediate Airspace including Heading, Altitude, Latitude, Longitude as well as City, State, Region, Country, Hemisphere and additionally Airspace information pertaining to Public, Private, Military or other Restrictions or allowances; such as maximum air speed, altitude, elevation or for ground vehicles, the current speed limit for that section of road or other laws pertaining to specific machines and each data registry node has a reference entry on the registry for all relevant information, which is displayed on the console screen or device in digital, 2D & 3D format with modern touch features to allow for zooming in or out to see finite details or the greater picture.

In another aspect this invention presents the opportunity to accelerate autonomous machine technology and the exact volume of space used by any given machine can be communicated with other relevant machines to ensure advanced safety.

In another aspect navigation services utilizing this invention know their exact heading by tracking the stream of recently interacted data registry nodes to determine machines exact movement through physical space revealing the exact direction as the program has the precise cardinal directions programmed in to provide a precise heading accurate to, but not limited to, 1° increments.

In yet another aspect this invention provides exact data of the precise volume of physical airspace used which can be utilized to fine tune the flight systems software of VTOL & other aircraft as well as autonomous vehicles.

In another aspect, as this invention pertains to navigation services, the use of a predictive algorithm based on the heading and input flight controls to prepare a short list of potential data registry nodes to minimize the registry search time and instead of querying all nodes it queries a select few & sets up multiple potential virtual nodes based on its predictive pattern and continues a predictive path as far out as is necessary until a change is applied to the flight controls at which time it adjusts the query with a new directional query made possible by this invention.

In still another aspect of this invention each device or machine has a sensor that acts as a peripheral to the main system. Each device or machine is the same as a virtual headset navigating its way through physical space.

Additionally, the main system is centrally located in one space and casts the network that each device or machine views and interacts with to know their precise location.

In another aspect this invention, which is initially internet based, will be a self-contained system that does not need any outward infrastructure by combining the entirety of this process with other processes such as a machine learning program, programmed intelligence derived from the data of this process and a virtual/physical syncing process that happens a million times per second to enable the machine or device to know its exact location without any outward infrastructure by triangulating and syncing with the natural and manmade physical & virtual data up to 500 ft elevation via LiDAR then switching to celestial or landmark triangulation or a combination of both up to the outer edges of the atmosphere to provide that same location data but without outward infrastructure.

With these and other objects in view that will more readily appear as the nature of the invention is better understood, the invention consists in the novel process and development, combination and arrangement of software programming hereinafter more fully illustrated, described and claimed, with reference being made to the accompanying drawings in which:

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 illustrates a data registry node suspended virtually in a 3D environment that is utilized to provide a reference point for this invention.

FIG. 2 illustrates a small cluster of virtual data registry nodes and demonstrates the measurability by utilizing precise evenly spaced nodes.

FIG. 3 illustrates the sensor or peripheral of the device or machine utilizing this invention from a first-person view which is approaching the cluster of nodes.

FIG. 4 illustrates that the sensor or peripheral of the device or machine has interacted with the most central node indicated by the change in virtual nodes brightness.

FIG. 5 illustrates the basis of how this invention stores precise location & pertinent information in a registry and how the registry has a corresponding reference that matches the code on the node in FIG. 4.

FIG. 6 illustrates how this invention can view its physical location virtually in reference to natural and manmade structures.

### DETAILED DESCRIPTION AND BEST MODE OF IMPLEMENTATION

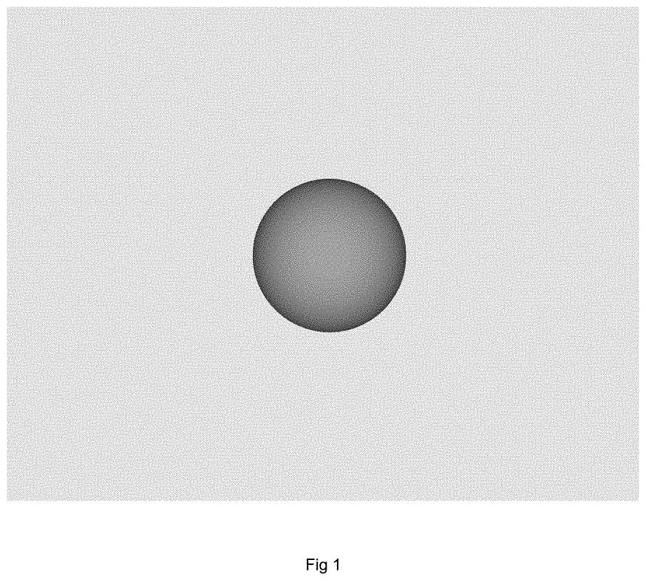

FIG. 1 Pictured is a virtual data registry node suspended in a 3D environment. Data registry nodes are virtual reference points that correspond to a registry that contains a more complete description that pertains to that nodes precise location in its 3D physical environment and they are not readable or visible except by this invention which references detailed location and pertinent regulatory information pertaining to road way, water way, structure, space or airspace and they are placed virtually in three dimensional physical reality to provide precise location and pertinent data that is used to show machines or electronic devices their exact location and applicable regulations and restrictions within a 3 dimensional space via land, air or water. In the case of this invention virtual data registry nodes can take up as little as, but not limited to, an eighth of an inch squared depending on the application, and in this illustration data registry nodes are represented as having a spherical shape; however shape does not determine the function of this process.

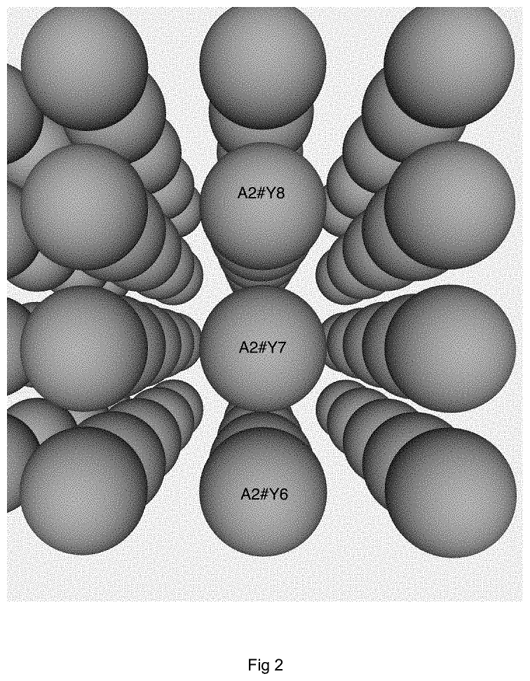

FIG. 2 Pictured is a small grouping of virtual data registry nodes each identified by a code only visible to this invention by virtual camera or detected by a sensor and each node references a specific entry in a registry that pertains to the nodes exact location in 3D physical space. The purpose of this figure is to demonstrate on a smaller scale that data registry nodes are evenly spaced virtually within a three-dimensional space to create a measurable & knowable environment so that precise location, measurement and navigation services can be built upon this platform.

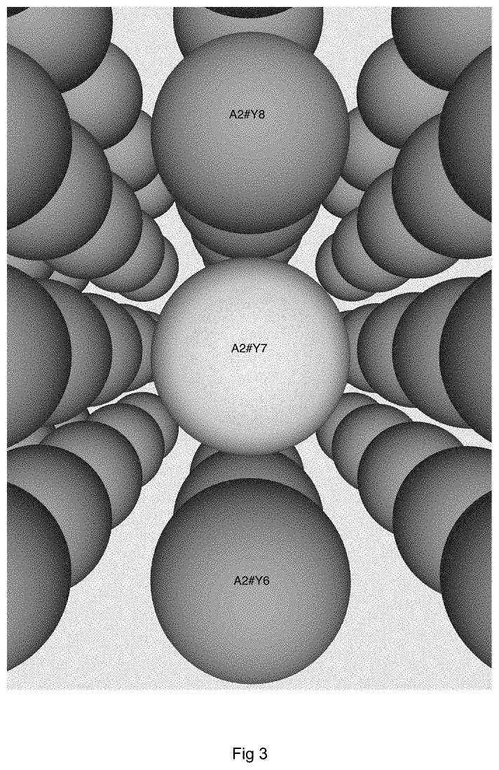

FIG. 3 This is the same cluster of data registry nodes from FIG. 2 that appear closer, demonstrating the sensor or peripheral of the device or machine is approaching the nodes from a first-person view.

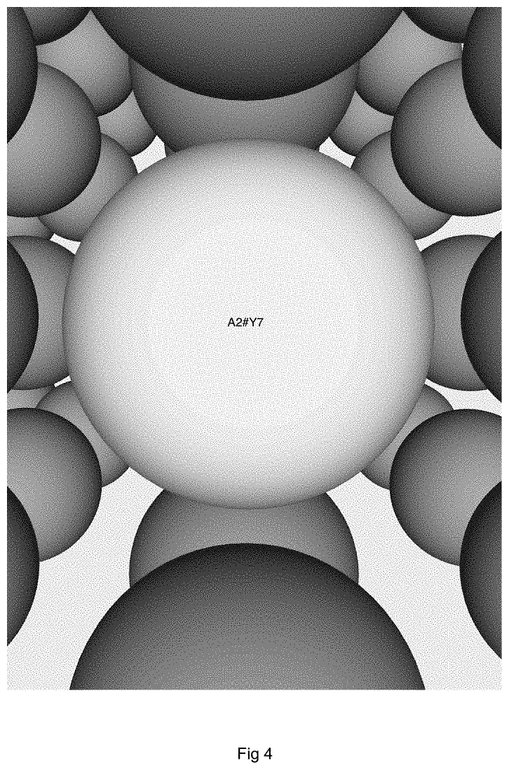

FIG. 4 This picture illustrates that the sensor has interacted with the node. Upon interacting the system is programmed to automatically displays the information pertaining of that specific node's location and other pertinent information on the display in its various formats.

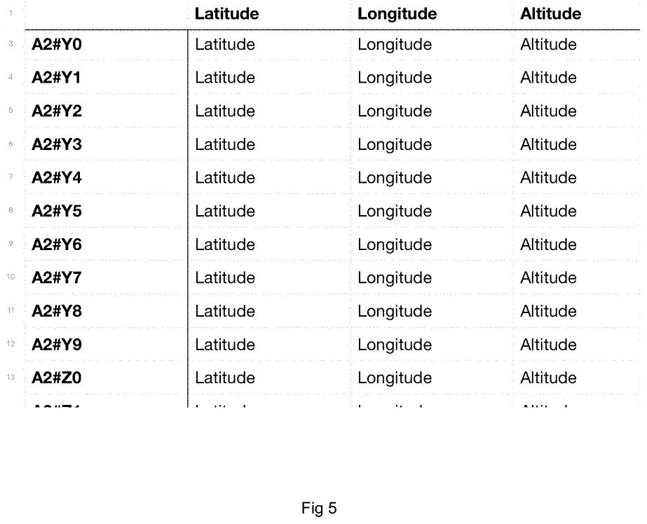

FIG. 5 This picture illustrates that the invention utilizes a registry of information that pertains to each specific data registry node and is a sample only and does not show all potential data that can be entered for any one specific entry point. The reference entry A2#Y7 on the registry contains specific location and other pertinent information for the actual real-world 3D physical space that its corresponding virtual data registry node has been fixed in place.

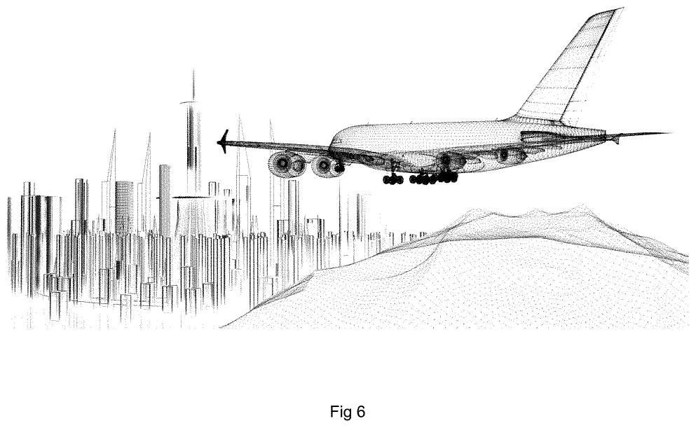

FIG. 6 Virtual data registry nodes are used to develop the real physical surroundings of manmade and natural structures within this invention by syncing the physical layout with all corresponding virtual data registry nodes. In this picture the grid like structure over the hill below the Aircraft is virtual and matches exactly with the physical environment. The Aircraft pictured is a virtual representation of the Aircraft's actual physical shape and shows the aircrafts actual location in 3D virtual space which corresponds to the aircraft actual location in 3D physical reality. Each machine will have a virtual representation that matches its physical dimensions. Buildings and other structures will also be represented virtually and will be matched up with the environment. For Example, All Structures, Roadways, Towers, Telephone wires, Electric wires, mountains, hills, outcroppings and the like are relevant to Aircraft and their systems will include that & other pertinent information. This is accomplished by syncing up the virtual data registry nodes with physical structures to provide a basis for obstacle avoidance. As commercial and residential development ensues and new obstacles or roadways arise, that info will be added to system updates provided immediately as it pertains to all users. Further, the visualization of the data captured by this invention can be viewed in multiple ways such as displayed in this picture will have ability to view the machine from any angle with respect to its actual full 3D environment.

The present invention has been described in relation to a preferred embodiment and several alternative preferred embodiments. One of ordinary skill, after reading the foregoing specifications, may be able to affect various other changes, alterations, and substitutions or equivalents thereof without departing from the concepts disclosed. It is therefore intended that the scope of the Letters Patent granted hereon be limited only by the definitions contained in the appended claims and equivalents thereof.

What is claimed is:

1. A global positioning method comprising: a virtual software program;
a computer server; and
an internet connected virtual interactive sensor; and
an internet-based interface; and
a host machine or device; and
an interactive touch screen display.

2. A global positioning method comprising: a virtual software program made up of a global virtual interactive environment that spans all internet connected airspace above and below ground and below sea level and consists of a grid of fixed virtual nodes that contain virtually accessible information and form an underpinning system for information exchange.

3. A global positioning method comprising: a program or application installed locally to connect the vehicle, machine or device to the virtual interactive environment that is comprised of an artificial reproduction topographical map of earth that includes airspace above and below ground where information is available created to contain a precisely scaled version of the grid of fixed virtual nodes that matches precisely to provide an accurate visual representations of the virtual sensors exact location in 3D physical space.

4. A global positioning method as in claim 1, wherein a computer server consisting of multiple computers run a virtual software program.

5. A global positioning method as in claim 1, wherein an internet connected virtual interactive sensor uses virtual interactive technology as commonly used in virtual controllers and virtual gloves to access information contained in each individual fixed virtual node upon coming into proximity of each fixed virtual node.

6. A global positioning method as in claim 2, wherein triangulation and cameras are not required to achieve an exact location.

7. A global positioning method as in claim 2, wherein each fixed virtual node is tied to an exact location in 3D physical space and is placed in a grid like fashion touching or spaced apart as large or as small and as close or as distanced as is required for the specified application.

8. A global positioning method as in claim 2, wherein each fixed virtual node is coded to contain that specific fixed virtual node's exact location data, and other pertinent or promoted information to provide location services, measurement services, boundary services, information services as well as virtual advertising services.

9. A global positioning method as in claim 2, wherein fixed virtual nodes are coded to provide an outlining boundary of all fixed physical manmade and natural surfaces and objects that they come into physical contact with.

10. A global positioning method as in claim 3, wherein the artificially placed grid of fixed virtual nodes is synced with the exact location information detected by the installed virtual interactive sensor.

11. A global positioning method as in claim 5, wherein each virtually interactive sensor acts as an account and allows the virtual software program to track the vehicle, machine, or devices interaction with the fixed virtual nodes as those nodes are interacted with.

12. A global positioning method as in claim 8, wherein businesses can utilize groups of fixed virtual nodes to run virtual advertising within specified locations to capture relevant passer by business.

13. A global positioning method as in claim 9, wherein machines and devices can know their exact location in proximity to their immediate and greater physical environment to establish a basis for advanced obstacle avoidance for machines and end-users.

14. A global positioning method as in claim 11, wherein a virtual interactive sensor is tracked by a virtual software program as the sensor interacts with each fixed virtual node and provides real time data of the pertinent movement tracking data for other machines, vehicles, or devices.

15. A global positioning method as in claim 13, wherein all users see all fixed physical objects and movement of other sensor enabled objects to aid in safe travel, congestion avoidance & collision avoidance to allow the end-user to see a virtual 3D representation of the connected vehicle & their exact location in their immediate surrounding 3D physical environment including other connected machines displayed on a screen with a bird's eye view or 2D view.
